(19) United States
(12) Patent Application Publication
(10) Pub. No.: US 2009/0311374 A1
(43) Pub. Date: Dec. 17, 2009

(54) INTEGRATED CORN PROCESSING

(76) Inventors: Michael J. Beaver, Victoria, MN (US); Eugene J. Fox, Dayton, OH (US); Joel Ingvalson, Minneapolis, MN (US); Doug Kotowski, Minneapolis, MN (US); Alexander Patist, Minnetonka, MN (US); Ian C. Purtle, Plymouth, MN (US); Michael J. Tupy, Crystal, MN (US); Christopher Tyler, Minnetonka, MN (US); Michael Van Houten, Carmel, IN (US); Luca Zullo, Tonka Bay, MN (US)

Correspondence Address: CARGILL, INCORPORATED, P.O. Box 5624, MINNEAPOLIS, MN, 55440-5624, US

(21) Appl. No.: 11/719,385

(22) PCT Filed: Nov. 15, 2005
(86) PCT No.: PCT/US05/41190

§ 371 Date: Sep. 1, 2009

Related U.S. Application Data
(60) Provisional application No. 60/628,069, filed on Nov. 15, 2004.

(51) Int. Cl. C10L 5/44; A23L 1/236; A23L 1/00; A23K 1/00; A21D 2/00; A23L 1/186

(52) U.S. Cl. 426/18; 44/605; 426/548; 426/618; 426/623; 426/622

(57) ABSTRACT

The invention provides an integrated corn processing model and plant which can be used to generate grits, ethanol, energy, starch, sweeteners, gluten, fermentation products, corn meal and oil in a manner that allows the controller to shift outputs depending on process economics and availability of inputs.

This application claims the benefit of U.S. Provisional Application No. 60/628,069 filed Nov. 15, 2004, which is incorporated herein by reference in its entirety.

### FIELD OF THE INVENTION

The present invention is directed to an integrated corn processing model and plant which can be used to generate grits, ethanol, energy, starch, sweeteners, gluten, fermentation products, corn meal and oil in a manner that allows the controller to shift outputs depending on process economics and availability of inputs.

### BACKGROUND

Corn is traditionally processed using one of two methods, wet-milling and dry-milling. Wet-milling is more capital intensive and energy intensive. Wet-milling, however, allows for a better separation of the components in the corn, which in turn allows for higher purity products to be made, such as, for example high fructose corn syrup, starch, and corn oil. Dry milling can be generally described as the mechanical grinding of kernels of corn. The milled corn can then be further separated into ground-corn components, such as grits, bran, hominy feed, and germ. Applications that are particularly well suited for whole dry ground corn are for example whole corn foods and feedstocks for fermentation.

The differences between dry-milling and wet-milling have led to the common practice of locating dry corn mills next to ethanol fermentation facilities so that ethanol can be produced using the cheapest feedstock. However, the processing involved in both a wet-mill and a dry-mill require energy which can be a significant cost of producing products from either process. Also, as market conditions shift (i.e. ethanol prices drop, energy prices increase, or starch prices increase) it would be desirable to be able to shift resources to make alternative products.

Hence, it is desirable to have a method of having the option of making products from both dry-milling and wet-milling such that costs of production are lessened and maximum profit can be realized.

### SUMMARY

Provided herein are methods of fractionating corn into one or more portions and making products from these portions in such a way as to provide flexibility relating to which products are made and what methods are used to make them. The fractionation step allows for multiple products to be made from whole kernel corn such that the best economics can be achieved. A controller (i.e. a person, group of persons, or computer program) can shift between which products are being produced at any given time such that the largest economic benefit can be made.

In one embodiment, methods of generating energy from one or more portions of whole corn kernels are described. These methods involve separating one or more whole corn kernels into one or more portions and oxidizing at least one of the one or more portions to create one or more types of energy. The energy produced can be in the form of thermal energy, electrical energy and mixtures thereof. In one embodiment, the one or more portions of whole kernel corn are selected from the group consisting of low starch fraction (LSF) and a high starch fraction (HSF). As used herein, LSF also refers to high oil fraction (HOF) and high fat fraction (HFF). Additionally, HSF also refers to low oil fraction (LOF) and low fat fraction (LFF).

In another embodiment the method involves using at least one of the one or more portions of whole kernel corn to make one or more additional products (in addition to energy) such products include for example starch, high fructose corn syrup, corn syrup, sweeteners, fermentation feedstock (feedstock is useful for the production of ethanol, citric acid, itaconic acid, lactic acid, and the like), extracted LSF (also useful as a fermentation feedstock), animal feed, bran, grits, gluten meal and combinations thereof. Also, included are methods of making by-products (products made at the same time a target product is made). These products and by-products can be oxidized to produce energy, such as via gasification or combustion. In additional embodiments the one or more portions of whole kernel corn is LSF and wherein the LSF contains less than 50% intact germ.

Other methods that are provided herein are methods dividing a corn kernel that include fractionating at least one corn kernel having a range of moisture from about 8 wt. % to about 22 wt. %, into a higher starch fraction and a lower starch fraction, wherein, the higher starch fraction has an starch concentration greater than that of the corn kernel and the lower starch fraction has an starch concentration less than that of the corn kernel, and wherein the low starch fraction contains less than 50% intact germ. The resulting fractions or portions can be used in additional processes such as energy production, fermentation, oil production, wet-milling, animal feed production, sweetener production, starch production and combinations thereof. In some embodiments that fractionation will include using a debranning machine such as the Buhler L machine or machines that can be set up to provide a low starch fraction and a high starch fraction, wherein the high starch fraction will have less than 50% of the germ intact as compared to the germ intact in the whole kernel corn. In other embodiment that low starch faction can be expanded, or formed into a shape that the oil contained therein can be more easily extracted.

Additional methods provided herein are methods of producing one or more products from a corn milling plant (either a wet-milling, dry-milling plant or a combination thereof). These methods involve fractionating at least one whole corn kernel into at least two portions and producing energy and at least one additional product from the at least two portions. The at least one additional product produced can be any corn derived product. For example, starch, high fructose corn syrup, corn syrup, sweeteners, fermentation feedstock (feedstock is useful for the production of ethanol, citric acid, itaconic acid, lactic acid, and the like), extracted LSF (also useful as a fermentation feedstock), animal feed, bran, grits, gluten meal and combinations thereof can be made using the disclosed methods.

These and other embodiments will be appreciated upon reading the following detailed description.

### BRIEF DESCRIPTION OF THE FIGURE

FIG. 1 is a process flow diagram that shows the connections between the various methods described herein.

### DETAILED DESCRIPTION

The integrated corn processing model and plant that is described herein includes components and methods for generating various products such as, grits, ethanol, energy, starch, gluten, corn meal and oil. One of ordinary skill in the art will appreciate that as economic conditions and input availability change it would be advantageous to be able to increase production of one or more products while decreasing the production of others. For example, the integrated corn processing model and plant allows a controller to shift to producing energy when energy production costs more than the profit available from producing corn oil and meal.

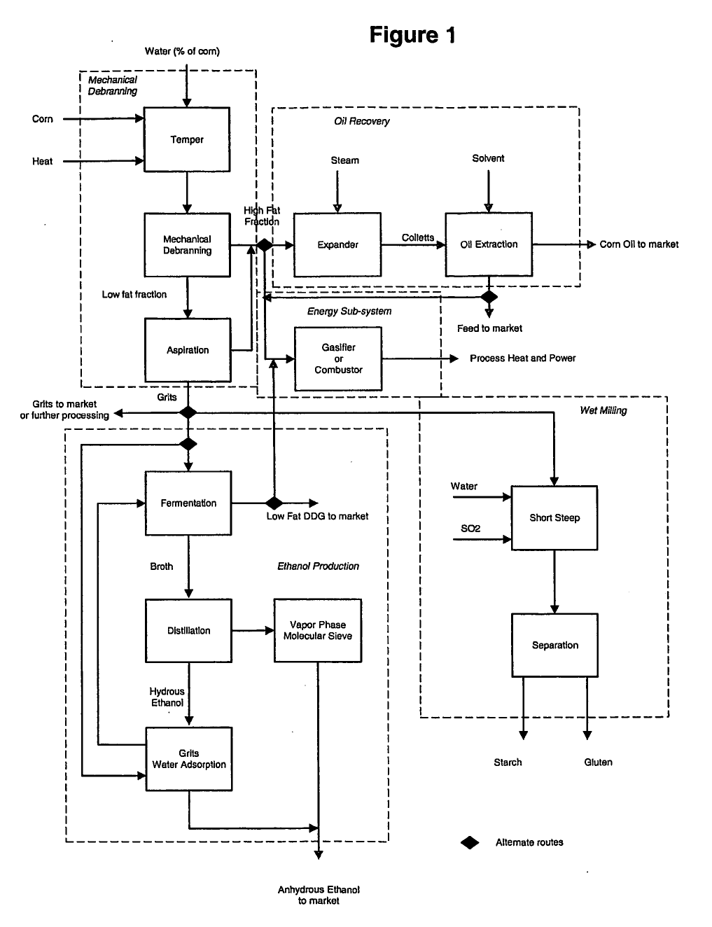

FIG. 1 is provided to illustrate the overall components of the corn processing model and/or plant and shows the overall relationship of the various sub-processes in the model. The initial separation of the corn can be a random separation or a purposeful separation. In some embodiments purposeful separation will result in a low starch fraction (LSF) and a high starch fraction (HSF) (basic steps for this initial process are identified in the Mechanical Debranning portion (also referred to as “I” throughout the specification) of FIG. 1. Similarly, the Oil Recovery portion of FIG. 1 that shows the oil production process of the model is also identified throughout the specification as “II”. The Energy Sub-System portion, or energy generation portion, of FIG. 1 is also identified as “III” throughout the specification FIG. 1, as well as in the text. The Ethanol Production portion, or fermentation portion, of FIG. 1 is also identified as “IV” throughout the specification and finally the Wet Milling portion, or starch and gluten production process, is also identified as “V” throughout the specification.

There are many advantages associated with controlling the inputs and outputs related to a plant running using the model. Among these advantages is the ability to run the plant in such a way as to have a minimal environmental impact. The corn can be separated in such a way as to use the HSF for production of fermentation products or other starch and fermentation products and the LSF can be used at least in part to create energy to support the energy needs of the processes being run at the plant. Hence, all of the main energy inputs for production come from the corn kernel itself and reliance on fossil fuels is decreased or eliminated.

### I. Separation

A. Inputs Into the Separation Process

The maize kernel is covered by a water-impermeable cuticle. The pericarp is the mature ovary wall which is beneath the cuticle, and comprises all the outer cell layers down to the seed coat. It is high in non-starch-polysaccharides, such as cellulose and pentosans. Because of its high fiber content, the pericarp is tough. The tip cap, where the kernel is joined to the cob, is a continuation of the pericarp, and is usually present during shelling. It contains a loose and spongy parenchyma.

Whole kernel corn seed or grain harvested from any of several different types of corn plants can be used in the present invention. These types of corn plants are, for example, hybrids, inbreds, transgenic plants, genetically modified plants, or a specific population of plants. Useful corn grain types include, for example, flint corn, popcorn, flour corn, dent corn, white corn, and sweet corn. As used herein, the terms “whole kernel” or “whole corn” mean a kernel that has not been separated into its constituent parts, e.g. the hull, endosperm, tip cap, pericarp, and germ have not been purposefully separated from each other. Purposeful separation of one corn constituent from another does not include random separation that may occur during storage, handling, transport, crushing, flaking, cracking, grinding, or abrading. A purposeful separation of the constituent part is one wherein at least 50% of one constituent, e.g., germ, has been separated from the remaining constituents. As used herein, the term “corn material” refers to whole corn, cracked corn, screened corn, and aspirated corn, whether or not conditioned or tempered.

As mentioned above, the starting material for the separation step is corn and basically any type of corn can be used. However, the way that separation is achieved might have to be altered depending on corn hardness, moisture content, and oil content.

Upon separation, the LSF will have a concentration of starch on a dry basis that is less than the concentration of starch on same basis found in the original corn kernel. In some embodiments the LSF will have a starch content of less than 50%, 40%, 30%, 20%, or 10% on a dry basis. In some embodiments that the LSF will also have an increased concentration of oil as compared to the original corn kernel. In these embodiments the LSF can also be referred to as a high oil fraction HOF. The HOF will have an oil concentration that is higher than that of the original kernel on same basis.

In some embodiments, where mechanical de-germination is used, the separated germ will not be completely intact. For example, in some embodiments less than 50% of the germ will be intact and in other examples less than 40%, 30%, 20%, 10%, or 0.5% of the germ will be intact. Mechanical de-germination processes using the Buhler-L machine (AG, Germany) machine, or machines with similar capabilities will be useful for producing HOF with decreased intact germ levels.

Upon separation the HSF will have a concentration of starch that is greater than that of the original kernel on a dry basis. For example, the HSF may have starch content greater 70%, 80%, or 90% on a dry basis. In some embodiments the HSF will also have a low concentration of oil. In such embodiments the HSF can also be referred to as a low oil fraction (OF).

B. Separation Process

In some instances it maybe desirable to temper the corn prior to separation. Any tempering method known in the art is acceptable, including, but not limited to spraying water or sparging steam. For example a stacked cooker or rotary steamed tube heater may be used to temper. Alternatively, a steam jacket mixer may be used. In general, the corn is tempered in an appropriate amount of water for any suitable length of time, such as at least 15 seconds, 30 seconds, 1 minute, 2 minutes, and at least 30 minutes. In some embodiments the corn can be tempered or pretreated to prepare it for separation. Tempering may be done at a temperature and for a time sufficient to increase the differential hardness between the germ component and the remainder of the corn material. In one aspect, the corn material is tempered up to a maximum of about 1% additional moisture. In one aspect, the tempering increases the moisture of the corn material by up to a maximum of about 2%, about 3%, or about 4% additional moisture. In one embodiment, tempering comprises heating the corn material directly or indirectly and adding moisture to the corn material by spraying water, an aqueous solution, and/or sparging steam. Generally, tempering is desirable when the plant is being run such that it is important to have a better separation of the oil containing germ from the HSF. This is desirable when it is more profitable to generate corn oil than some of the other possible outputs. If tempering is not needed the corn can be directly put into the separation process.

Any separation process known by one of ordinary skill in the art will work. For instance, current dry milling or wet milling techniques that give rise to dividing the kernels into more than one portions, either random portions or purposefully distinct portions, can be used. For instance, methods of separating the corn into at least a LSF and a HSF can be any known in the art, for example grinding followed by screening to separate the LSF from the HSF, mechanical debranning using for example a Buhler-L apparatus (see also Example 1, below), cracking followed by screening, freezing the corn, mechanically fractioning and combinations thereof.

The HSF contains an endosperm component. This stream can be utilized for many applications in the food, chemicals, and industrial products industries. Due to its high starch content and lower oil and fiber concentrations this stream is an ideal feed source for many fermentation processes, including, but not limited to production of ethanol, carboxylic acids, amino acids and butanol. Other uses include using this as feedstock material to produce sweeteners, plastics as well as cosmetics and food applications.

When separation is done by cracking, corn kernels are conveyed into a cracking apparatus. After cracking, the large size pieces of cracked corn and medium size pieces of cracked corn are separated from the small size pieces of cracked corn, such as by screening. One screen that can be used in the process of the present invention is a Rotex screen with a 4 mesh mill grade with 5.46 mm holes (Rotex, Inc., Cincinnati, Ohio, Model #201GP). Other methods of separation include, but are not limited to, other methods of size separation or gravity separation known to those skilled in the art, such as, but not limited to, aspiration and cyclonic separation.

The medium and large size pieces of cracked corn are retained by the screen. The retained medium and large size pieces of cracked corn are ground in a mill or flaked in a flaker. A useful mill is the Fitzmill comminuter Fitzpatrick Company, Elmhurst, Ill.) fitted with a ¼ inch screen. Useful commercial-scale oilseed flakers can be obtained from French Oil Mill Machinery Company, Piqua, Ohio; Roskamp Champion, Waterloo, Iowa; Buhler AG, Germany; Bauermeister, Inc., Memphis Tenn.; Consolidated Process Machinery Roskamp Company, on the world wide web at http://www.cpmroskamp.com, and Crown Iron Works, Minneapolis, Minn.

Generally, the large size pieces of cracked corn comprise from about 11 wt. % to about 22 wt. % oil. The medium and small size pieces of cracked corn comprise from about 4.5 wt. % to about 8 wt. % oil

After being ground in the mill, the ground cracked corn is added to the stream being fed to the expander or pellet mill. After being flaked, the flaked cracked corn is added to the stream exiting the expander or pellet mill.

Optionally, the small size screened pieces of cracked corn may be aspirated to remove fines (bran). In one embodiment, the bran is added to the feed to the extractor. In one embodiment, the bran is extracted separately from other corn components. In one embodiment, the bran is used as a feedstock from which to extract one or more components of the bran, e.g. phytosterols. In one embodiment, the bran is used as fermentation feedstock. In yet another embodiment, the bran is used in a cattle feed. In an alternative embodiment, the aspiration of the bran is not performed until after the fractionation step. In this embodiment, the LSF is aspirated to remove the bran.

In either aspiration embodiment, a separate bran (fiber) stream results. The sugars associated with the fiber or pericarp are typically hemicelluloses, which are 5 carbon sugars such as Arabinose and Xylose. These carbohydrates have many uses in the food, industrial chemicals, and fuels markets. Because this stream has an elevated concentration of these key sugars, this stream can be used as a feedstock material to separate the carbohydrate sugars of interest. In addition, this stream can be feed directly into an ethanol fermentation process to utilize the sugars to produce ethanol. The bran (fiber) stream also contains valuable components such as phytosterols.

The LSF without the bran is a higher oil without (or with less) fiber stream. This stream contains elevated oil and protein concentrations and is an ideal feed source for industrial applications and has unique food uses. Due to its higher protein levels, this stream can be a good feed source for water, salt, pH, membrane, and/or alcohol protein extraction. This can lead to a protein concentrate for use in the food and industrial chemicals industry. Additionally this stream can be further processed via extraction with a solvent and/or the use of water and ultrasound for protein(s), amino acids or novel compounds. The LSF with the bran can be used as an animal feed source or as a food additive.

The small size screened pieces of cracked corn and/or screened and aspirated small size pieces of cracked corn can be fed to the fractionator, which separates them into a higher oil cracked fraction and a lower oil cracked fraction. In one embodiment, the lower oil cracked fraction is used as a feedstock for fermentation, corn wet milling, pet food, animal feed, food applications, and/or other processes. In one embodiment, the lower oil cracked fraction is combined with extracted corn meal. The combination may be used as a feedstock for fermentation, corn wet-milling, pet food, animal feed, food applications, and/or other processes.

In other embodiments the pretreatment may involve further drying of the corn to facilitate the separation of the LSF from the HSF. Drying may be accomplished by heating the corn or merely air drying the corn.

In some embodiments the tempering step will not be desirable because the moisture content of the LSF and/or HSF needs to be low. This is particularly true when one or more of the fractions are being used for energy generation. Generally, the energy generation portion of the process is more efficient if the starting material contains a minimum amount of moisture.

C. Outputs from Separation

The separation process may result in random portions of corn that are separated based upon the percentage of mass needed to run the processes chosen by the controller. For instance, if economic conditions indict that ethanol production and energy production are the most profitable products the portions of corn may be merely divided based upon needs of these two processes.

Purposeful separation may result in one or more of the following; HSF, LSF, and high bran fraction (HBF).

The high bran fraction can be used in food, including animal feed. The high bran fraction may also be used as an energy source for a combustor or gasifier. In some embodiments the energy creation will be such that the overall plant will be self sufficient or almost self sufficient, meaning that the plant will not need to rely on petrochemicals or external energy source to produce products (see Example III).

In one embodiment, the HSF is used as a feedstock for fermentation, corn wet milling, pet food, animal feed, food applications, and/or other processes. In another embodiment, the HSF is combined with the extracted, desolventized meal (extracted LSF) and used as a feedstock for fermentation, corn wet milling, pet food, animal feed, food applications, and/or other processes. In one aspect of the present invention, the extracted, desolventized meal can be used as a feedstock for fermentation, corn wet milling, pet food, animal feed, food applications, and/or other processes.

The outputs from the separation process may be additionally processed to prepare them for the next processing step. For instance them may be flaked to facilitate oil removal or enzyme treatment. The outputs may also be conditioned and then conveyed to an expander or pellet mill. Oil can be then extracted from the expanded cracked higher oil fraction, alone or in combination with the flaked cracked corn and/or the ground cracked corn.

### II. Energy Production

A. Inputs Into the Energy Production Process

The cost of energy can be one of the largest contributors to the cost of products made by a corn milling plant and/or fermentation plant. Hence, the corn kernel itself can be used to produce energy that will lessen the cost of the end product. The corn kernel can be separated into random portions and a fraction, or percentage, of the random portions can be oxidized to create energy to run the plant or a portion thereof. In some instances the energy generated will be in excess of that needed by the plant and the energy itself can be sold as a product of the plant.

Portions of the corn kernels generated by the separation step can be randomly generated, i.e. with a complete disregard for whether more starch, oil, or protein is in one portion when compared to a second portion. This may be desirable when the plant is making masa based products such as tortillas and the like. However, generally, the separation step will provide two or more purposefully divided portions that differ such as a HSF, HBF or LSF. One or more of these fractions can then be used for energy production. The remaining portions that are not used for energy production can be sold as is or further processed to create corn related products and by-products such as starch, high fructose corn syrup, corn syrup, sweeteners, fermentation feedstock (feedstock is useful for the production of ethanol, citric acid, itaconic acid, lactic acid, and the like), extracted LSF, animal feed, bran, grits, gluten meal, and combinations thereof.

Additionally, the HSF, and/or LSF can be processed to produced various products such as oil, starch, fermentation feedstocks, sweeteners, and the like, and the leftover/remaining matter (by-products) after these various products are produced can be used for energy generation. For example DDGs, oil extracted LSF, bran, and the like can be used to generate energy and/or heat.

One of ordinary skill in the art can appreciate that any corn can be used in the process and that some types of corn will be more desirable depending on what the controller wants to produce in the plant. The controllers choice will be influenced by the costs of inputs and the market prices of the various products that can be produced by the plant. More specifically, if high fructose corn syrup prices are high the controller may run yellow dent corn to capture the starch and the remaining LSF can be used to create energy and/or heat. The generation of heat is particularly useful when the plant is using elevated temperatures and/or consumes steam during some of the processing steps, such as during oil extraction, steeping, fermentation and/or distillation.

B. Processing

One or more of the fractions and/or by-products from the various processes described herein can be used to generate energy. The energy can be created via methods such as combustion and/or gasification. Examples of suitable equipment for combustion are solid fuel boilers such as the Hurst Hybrid PF and Hurst Hybrid UF boilers (Hurst Boiler and Welding Co., Coolidge, Ga.). Examples of suitable equipment for gasification are designed by Host BV (Hengelo, NL) and by Ferco Enterprises LLC (Norcross, Ga.)

A fraction and/or by product can be burnt in a combustor and the heat can be used to generate steam. Depending on the pressure of the steam, the system will deliver low-pressure steam and/or high pressure steam. Low pressure steam is mainly used for thermal energy in the HSF cooking, steeping, fermentation and distillation processes. High pressure steam is more desirable when electricity production is desired, however, high pressure steam can also be used as a source of thermal energy.

In some embodiments it is desirable to use a high pressure boiler. The high pressure steam is expanded to a lower pressure in a steam turbine that produces electricity. The remaining low pressure steam is still used to deliver thermal energy (HSF cooking, steeping, fermentation and distillation). The boiler used in this process is any type of boiler which is suited to handle solid materials as a feed.

It is expected that some of the inputs into the energy generation process described herein will exhibit slagging ashes when they are burnt. Slagging ashes are caused by the ash of the fuel having a melting temperature inferior to the combustion temperature. Slagging ashes are undesirable as they tend to solidify outside the combustion area and often produced tick and hard deposits on the boiler walls and pipes. These deposits are often the cause of considerable operational and maintenance problem and cause an overall reduction of the operating life of the boiler. Furthermore, the process of liquefaction and subsequent solidification upon cooling experienced by the ashes, causes the bonding of the minerals in the ashes in such a way to make this material unsuitable for fertilizer applications.

For embodiments where slagging ashes are a problem gasification can be used to generate energy. In gasification a carbonaceous material is put in contact with at high temperature with an oxygen deprived environment. The amount of oxygen is less than what stoichiometry demands for full combustion and for that reason only a partial oxidation to carbon monoxide is carried out rather than the full oxidation to carbon dioxide typical of combustion processes. The product of this process is a combustible gas (called syngas) made up mostly by CO which can be use as a natural gas substitute in most natural gas boilers with no or marginal modification to the burner. By limiting the reaction extent to partial oxidation to CO, one carries out gasification at substantially lower temperature (750-800 C) temperature than combustion. In turn this prevents most ashes from slagging and allows them to maintain a high value as a fertilizer. Gasification of material of biological origin is well know in the art.

C. Outputs from the Energy Production Process

Oxidation of the corn kernel portions produces ashes. Ashes of biological material concentrate the residual non-carbonaceous and non-combustible components of the material. Metals and inorganic salts are often found in the ashes. The minerals contained in the ashes of material of vegetable origin were scavenged by plant while growing in the field. The minerals contained in the ashes are often of considerable fertilizer value as they represent substances needed for the growth of the plant. The continuous removal of nutrients from the ground is offset by the farmer by using synthetic fertilizers whose production employs non renewable fossil fuel. The use of synthetic fertilizer is often cited by the critics of ethanol production as detrimental to the sustainability and overall energy balance of ethanol. The embodiments presented herein provide a better overall energy balance than has previously been shown for ethanol product. This is largely because the ashes from the oxidation of the LSF contain most of the minerals in the corn kernel and can be returned for dispersion in the field whence the corn came. Additionally, this adds a potential revenue stream for the controller.

Any extra electricity produced by the energy production in addition to the energy required by process can be sold in the energy market and can be viewed as another product produced by the plant. Given the correct market conditions a controller could choose to burn the energy rich portions (HOP, LSF, SEM, and the like) of the corn kernel rather than produce traditional corn related products.

### III. Integration of Processes I-V

An integrated corn processing plant can be envisioned in which all the operations described by process I-V are present. Such plant would be in principle similar to an oil refinery where the operator can alter the product mix depending upon market demand and type of feedstock. In an integrated corn processing plant, the operator would be faced with several opportunities to optimize the process flow depending upon quality and quantity of the corn delivered to the plant and market demand for products and/or market prices of the same. As an example, in a period of high corn oil price the operator may decide to extract oil and/or purchase corn varieties that are particularly rich in oil while continuing to produce thermal energy for the plant by oxidation of SEM. This latter decision would be based on an arbitrage between the value of SEM in the feed market and the value of energy. Should the former exceed the latter, the operator may decide to revert to use purchased fuel (e.g. natural gas) and divert SEM to the feed market. To achieve this goal, care should be taken to design an energy subsystem capable to operate on a variety of fuels either internally produced or purchased either as exclusive feed or in any possible mix (co-firing).

In another situation the operator may decide to purchase relatively low oil content corn and because of high energy price and lesser demand on oil, to skip the extraction of oil and divert the entire untreated LSF to energy use. It can be envisioned that such situation may deliver more energy to the plant than what is necessary for its operation. In that case, the plant may export energy and obtain a profit. Another similar arbitrage could be done between sending the HSF to saccarification and fermentation directly and the sending it to a short steep to separate the starch from the protein before saccarification and subsequent fermentation of the starch. In the former case the protein in the HSF would be recovered as DDG while in the second case the protein would be recovered as corn gluten meal (CGM). Traditionally CGM commands a premium over DDG. However the processing steps to produce CGM are more expensive. The arbitrage between the two routes would be determined by ability of the differential value of the two product to cover the higher processing cost of CGM meal recovery which in turn is related to the energy cost and the amount of self-produced energy vs externally purchased energy. Another possible variable in this arbitrage would be determined by the higher flexibility of starch as a fermentation feedstock as compared to the unprocessed LSF. The former may be more suitable as feedstock for a variety of complex fermentations, the desirability of which will depend upon market demand of their products as opposed to market demand of ethanol.

Those examples are indicative, but not exclusive of the type of operational flexibility and efficiency created in an integrated corn processing plant. An integrated corn processing plant would give the operator the opportunity to extract the maximum economic value out of corn product by at any time optimizing the process and choosing the processing route that deliver the product mix of highest profitability based on external market demands, energy prices and corn types, availability and prices.

### Example I

### Separation

The basic steps for separating the HOF from LOF or the HSF from the LSF are basically the same for both high oil corn and low oil corn. The specific example provided below is for high corn oil.

High oil corn grain 1 (LH310 (inbred, Holdens Foundation Seeeds)×HOI 001, see U.S. Patent Publication Nos. 2003/018269 and 2003/0172416, incorporated herein by reference) and high oil corn grain 2 (Top Cross Blend seed corn, purchased Spring 2003, grain harvested Fall, 2003, Indiana) from storage was metered in to steam jacketed paddle mixer with a retention time of about 7 minutes. The corn was heat tempered at 90° F. The tempered corn was then conveyed to a Buhler—L apparatus, (Buhler GmbH, Germany) where the hull and softer tissue was abraded to become the lower oil fraction (“LOF”) and separated from the higher oil fraction (“HOF”). The results of the analysis of the grain, the HOF and the LOF are displayed in Table I-1.

TABLE I-1

| | Moisture | Oil | Split (wt. %) |
|---|---|---|---|
| Grain 1 | 12% | 8.6% | |
| HOF 1 | | 14.5% | 52% |
| LOF 1 | | 2.3% | 48% |
| Grain 2 | 16% | 6.7% | |
| HOF 2 | | 13.5% | 43% |
| LOF 2 | | 1.7% | 57% |

These results indicate that the oil level in over half of the corn material is reduced to less than 2.5 wt % of the LOF, allowing this fraction to bypass the expensive extraction step.

### Example II

### Oil Extraction

A. High Oil Corn

The HOF from Yellow dent #2 corn was expanded using a model DFEA-220 expander (Buhler GmbH, Germany) to create collets. Moisture was introduced in the form of steam into the expander barrel. The rate of steam addition ranged from 6.0 to 6.8%. The expanded HOF was cooled in a horizontal ambient air cooler that reduced the moisture content to between 10.13% and 12.45% moisture. The HOF was expanded to make it suitable for presentation to a full-scale solvent extractor.

Two truckloads of expanded HOF were metered into a full-scale extraction process at an inclusion of 23-32% HOF. The balance was wet milled germ expeller cake. The trucks were unloaded into the wet milled germ flow over a 3.5 hr period. The combination was extracted in a shallow bed Crown Model III extractor. The extractor is sized for 1000 T/day.

The following table shows results of different sample points during the trial:

TABLE II-1

| | Fat % | Protein % | Moisture % | FFA % |
|---|---|---|---|---|
| Extractor Feed | 16.0-17.2 | — | 4.96-7.06 | 2.0-3.4 |
| Extractor Discharge | 0.98-1.33 | — | 7.80-8.95 | — |
| DC/DT Discharge | 2.77-4.92 | 19.02-20.21 | 10.99-12.18 | — |
| Finished Oil to Storage | — | — | — | 1.4-1.7 |

### Example III

### Energy Production

The data derived from the oil extraction described in Example IIA was used to create an energy generation model for a plant that is both processing corn (including fermentation of corn) and creating energy from portions of corn. The model involved making various assumptions regarding the relative percentage of each component in the starting corn as well as making assumptions regarding energy production for products from the plant.

A mass balance of using the separation step and the division of the kernels into a HSF and LSF was calculated at a feed rate of 55,000 bushels/day of No. 2 yellow dent corn (see Tables III 1-17). The mass balances provided in these tables are presented in the alternative, for example when starch values are provided it is an assumption that ethanol is not being made. Energy production based upon the mass balance was also calculated and the results are shown in Tables III 18-21. Finally, the energy consumption for various ethanol production processes is shown in Tables III 22-24.

The mass balance data Table III-1 shows the assumptions used in the energy production model to estimate the % mass contributions of the various corn components. Table III-2 provides the assumed amount of water that is added to the process which was equal to 3% in weight of the corn feed to the process. Table III-3 shows a breakdown of contributions of the components in the LSF, which includes the bran fraction recovered from the aspiration of the HSF. Table III-4 shows the breakdown of the contributions of the HSF after the bran has been removed. Table III-5 shows the germ contribution to the energy production model. The germ is derived from a corn wet milling plant and it was added to the LSF after the LSF had been expanded to form collets. The germ was added to the LSF collets to achieve the volumes necessary to use a commercial scale oil extraction facility. The ratio of LSF collets to germ in the model is 4:6. Table III-6 provides an estimate of the total crude oil produced by the combination of the LSF collets and the germ. Table III-7 shows a breakdown of the components of the solvent extracted meal. The values in Table III-7 represent the solvent extracted meal that is the result of the LSF collets and the germ from wet milling. Finally, Tables 8-16 show the various products and there relative contribution for a plant producing ethanol or starch and gluten.

TABLE III-1

| Corn | 128,333.33 lb/hr | 3,080,000.00 lb/day | 55,000 bu/day |
|---|---|---|---|
| Ash | 1.32% | | |
| Fat | 3.38% | | |
| Fiber | 8.41% | | |
| Protein | 8.20% | | |
| Starch and | 63.67% | | |
| Sugar | | | |
| Water | 15.01% | | |

TABLE III-2

| Water | 3,850.00 lb/hr | 92,400.00 lb/day |
|---|---|---|
| Water | 100% | |

TABLE III-3

| LSF + bran from HSF | 35,284.62 lb/hr | 846,830.94 lb/day |
|---|---|---|
| Ash | 3.20% | |
| Fat | 8.21% | |
| Fiber | 17.04% | |
| Protein | 11.10% | |
| Starch and Sugar | 41.45% | |
| Water | 19.00% | |

TABLE III-4

| HSF-bran | 96,898.71 lb/hr | 2,325,569.04 lb/day |
|---|---|---|
| Ash | 0.58% | |
| Fat | 1.49% | |
| Fiber | 4.94% | |
| Protein | 6.82% | |
| Starch and Sugar | 69.23% | |
| Water | 16.93% | |

TABLE III-5

| Germ (from wet mill) | 52,926.93 lb/day | 1,270,246.39 lb/day |
|---|---|---|
| Ash | 8.76% | |
| Fat | 29.23% | |
| Fiber | 14.88% | |
| Protein | 15.73% | |
| Starch and Sugar | 16.41% | |
| Water | 15.00% | |

TABLE III-6

| Crude Oil to Market | 18,291.55 lb/hr | 438,997.16 lb/day |
|---|---|---|
| Oil | 99.86% | |
| Moisture | 0.14% | |

TABLE III-7

| SEM (LSF collets + germ) | 69,920.01 lb/hr | 1,678,080.19 lb/day |
|---|---|---|
| Ash | 8.24% | |
| Fat | 0.15% | |
| Fiber | 19.86% | |
| Protein | 17.51% | |
| Starch and Sugar | 33.34% | |
| Water | 20.90% | |

TABLE III-8

| Waste Water | 13668.7428 lb/hr | 328,049.83 lb/day |
|---|---|---|
| Ethanol | 0.10% | |
| Water | 99.90% | |

TABLE III-9

| CO2 | 31813.91979 lb/hr | 763,534.07 lb/day |
|---|---|---|
| CO2 | 100.00% | |

TABLE III-10

| Broth | 335485.442 lb/hr | 8,051,650.61 lb/day |
|---|---|---|
| Ethanol | 10.00% | |
| Water | 90.00% | |

TABLE III-11

| Bottoms | 302205.824 lb/hr | 7,252,939.78 lb/day |
|---|---|---|
| Ethanol | 0.10% | |
| Water | 99.90% | |

TABLE III-12

| Hydrous Ethanol | 44261.89193 lb/hr | 1,062,285.41 lb/day |
|---|---|---|
| Ethanol | 90.00% | |
| Water | 10.00% | |

TABLE III-13

| Ethanol Recycle | 10982.27394 lb/hr | 263,574.57 lb/day |
|---|---|---|
| Ethanol | 60.00% | |
| Water | 40.00% | |

TABLE III-14

| Anhydrous Ethanol | 33279.61799 lb/hr | 798,710.83 lb/day |
|---|---|---|
| Ethanol | 99.90% | |
| Water | 0.10% | |

TABLE III-15

| DDG | 20554.64 lb/hr | 493311.24 lb/day |
|---|---|---|
| Ash | 3.10% | |
| Fat | 7.97% | |
| Fiber | 26.37% | |
| Protein | 36.45% | |
| Starch and Sugar | 11.10% | |
| Water | 15.00% | |

TABLE III-16

| Starch (dry basis) | 65369.97393 lb/hr | 1,568,879.37 lb/day |
|---|---|---|
| Protein | 2.00% | |
| Starch | 98.00% | |

TABLE III-17

| Gluten (dry basis) | 15119.975 lb/hr | 362,879.40 lb/day |
|---|---|---|
| Ash | 3.72% | |
| Fat | 9.56% | |
| Fiber | 31.63% | |
| Protein | 35.08% | |
| Starch | 20.00% | |

The model assumes that mill water, enzymes usage and SO₂ will be consistent with typical milling industry usage.

To summarize the total outputs for the model when the plant is making ethanol from HSF are 14.52 LB/bushel ethanol, 7.98 lb/bushel oil (including contribution from germ), 14.52 lb/bushel DDG, 13.88 lb/bushel CO2, and 30.51 lb/bushel SEM (including contribution for germ).

Alternatively, when the plant is making starch instead of ethanol from the HSF the outputs are calculated to be 28.53 lb/bushel starch and 6.60 lb/bushel gluten.

The amount of energy used to produce the products is estimated and shown in Tables III 18-20. Table III-18 shows the energy expenditure associated with distillation, Table III-19 shows the energy expenditure associated with using molecular sieves, and Table III-20 shows the energy expenditure associated with using corn grits for adsorption of water instead of molecular sieves. The molecular sieves can be regenerated via dropping the pressure or running hot air over the sieves to evaporate the water (energy used to accomplished this is termed heat of regeneration which is included in the overall heat duty figure in Table III-19).

TABLE III-18
Distillation

| | | |
|---|---|---|
| N | 20 | |
| Cooling Duty | −47.8604 MMBtu/hr | −1148.65 MMBtu/day |
| Reflux Ratio | 2.63 | |
| Reboiler Duty | 75.894 MMBtu/hr | 1821.444 MMBtu/day |
| Reboil Ratio | 0.23 | |

TABLE III-19
Molecular Sieve Adsorption

| | | | | |
|---|---|---|---|---|
| Water | 4392.91 | lb/hr | 105429.8 | lb/day |
| Heat of Regeneration | 2600 | BTU/lb | | |
| Heat Duty | 11.42156 | MMBtu/hr | 274.1176 | MMBtu/day |
| PSA Duty | 0.196667 | MMBtu/hr | 4.72 | MMBtu/day |

TABLE III-20
Corn Grits Adsorption

| | | | | |
|---|---|---|---|---|
| Water | 4392.91 | lb/hr | 105429.8 | lb/day |
| Heat of Regeneration | 1500 | BTU/lb | | |
| Heat Duty | 6.589364 | MMBtu/hr | 158.1447 | MMBtu/day |
| PSA Duty | 0.113462 | MMBtu/hr | 2.723077 | MMBtu/day |

As mentioned above the mass balances were used to generate energy production values for the various products in the process. Table III-21 shows the assumed BTU/1b for each of the estimated components. Table III-22 shows the energy available from oxidizing DDG, Table III-23 shows the energy available from oxidizing the LSF, and Table III-24 shows the energy available for oxidizing the SEM.

TABLE III-21

| Heating Value | BTU/lb |
|---|---|
| Fat | 16200 |
| Fiber | 7200 |
| Protein | 7200 |
| Starch | 7200 |
| Moisture | −970 |

TABLE III-22

| DDG | 20554.64 lb/hr | 493311.2 lb/day |
|---|---|---|
| Ash | 3.10% | |
| Fat | 7.97% | |
| Fiber | 26.37% | |
| Protein | 36.45% | |
| Starch and Sugar | 11.10% | |
| Water | 15.00% | |
| Heating Value | 132.9572278 MMBTU/hr | 3190.973 MMBTU/day |
| Dry Heating | 135.9479279 MMBTU/hr | 3262.75 MMBTU/day |
| Value | | |

TABLE III-23

| Thrustock | 35,284.62 lb/hr | 846830.9 lb/day |
|---|---|---|
| Ash | 3.20% | |
| Fat | 8.21% | |
| Fiber | 17.04% | |
| Protein | 11.10% | |
| Starch and Sugar | 41.45% | |
| Water | 19.00% | |
| Heating Value | 126.539951 MMBTU/hr | 3036.959 MMBTU/day |
| Dry Heating | 130.3281712 MMBTU/hr | 3127.876 MMBTU/day |
| Value | | |

TABLE III-24

| SEM | 69,920.01 lb/hr | 1678080 lb/day |
|---|---|---|
| Ash | 8.24% | |
| Fat | 0.15% | |
| Fiber | 19.86% | |
| Protein | 17.51% | |
| Starch and Sugar | 33.34% | |
| Water | 20.90% | |
| Heating Value | 100.9630515 MMBTU/hr | 2423.113 MMBTU/day |
| Dry Heating | 105.1308517 MMBTU/hr | 2523.14 MMBTU/day |
| Value | | |
| Collet Fraction | 40.38522061 MMBTU/hr | 969.2453 MMBTU/day |
| Dry Collet | 42.0523407 MMBTU/hr | 1009.256 MMBTU/day |
| Fraction | | |

One of ordinary skill in the art will appreciate that one or more of these products (i.e. DDG, SEM, LSF, HSF, Crude oil, bran, Germ, etc.) can be oxidized for energy and also that just a portion of the one or more products can be oxidized. The model provided above does not provide for the energy that is needed to perform other parts of the processing within the plant. For example some of the processes that are known to require energy that are not addressed in the model are the energy for grinding the corn, removing the oil from the LSF collets and germ, and running the fermentors. However, these processes are considered to only contribute a small fraction of the total energy used by the plant and one of ordinary skill in the art can easily estimate the energy needed to run such processes and their contribution to the overall energy requirement of the process is small compared to the requirement of operation such as cooking, fermentation distillation, etc.

The results from the model show that it would be advantageous to utilize one or more portions of the corn kernel as an energy source. Which portion is used as an energy source will depend on market conditions and the price of energy. For example, using the model provided herein the estimated energy needed to distill ethanol is 1821 MMBTU/day which can be added to the energy needed to use molecular sieve adsorption which is 274 MMBTU/day for a total estimated energy usage of 2095 MMBTU/day. This energy could be provided by oxidizing the LSF which has been estimated to produce 4917 MMBTU/day assuming a 19% moisture value in the LSF (235% of the energy actually needed for ethanol distillation and dehydration). A contoller running such a plant would decide to oxidize the LSF when the price of the excess energy is of greater value than can be derived from selling the oil and SEM that would otherwise be produced. Part of that decision would also likely be influenced by the saving generated by not having to run the expander and extraction process.

### Example IV

U.S. Pat. Nos. 6,313,328 and 6,388,110 describe a commercial-scale method for processing whole kernel corn grain having a total oil content of at least about 8 wt. %, including the steps of flaking corn grain and extracting a corn oil from the flaked corn grain. U.S. Pat. No. 6,610,867 describes a process for extracting corn oil to form corn meal. The process generally includes the steps of cracking whole kernel corn having a total oil content of from about 3 wt. % to about 30 wt. % and extracting a corn oil from the cracked corn grain. (Flaking is not used in this process). All components of the whole kernel (in whatever form) are subjected to the extraction step, including those components with lower oil. By contrast, in the present process, the fractionation produces a high oil fraction and a low oil fraction. The lower oil fraction bypasses the extraction process and can go directly to feed or other uses. Only the higher oil fraction is prepared for extraction and extracted. This process doubles the plant throughput with a very minimal investment.

### Example V

High oil corn grain 1 (LH310 (inbred, Holdens Foundation Seeeds)×HOI 001, see U.S. Patent Publication Nos. 20031018269 and 200310172416, incorporated herein by reference) and high oil corn grain 2 (Top Cross Blend seed corn, purchased Spring 2003, grain harvested Fall, 2003, Indiana) from storage was metered in to steam jacketed paddle mixer with a retention time of about 7 minutes. The corn was heat tempered at 90° F. The tempered corn was then conveyed to a Buhler—L apparatus, (Buhler GmbH, Germany) where the hull and softer tissue was abraded to become the lower oil fraction (“LOF”) and separated from the higher oil fraction (“HOF”). The results of the analysis of the grain, the HOF and the LOF are displayed in Table 4.

TABLE 4

| | Moisture | Oil | Split (wt. %) |
|---|---|---|---|
| Grain 1 | 12% | 8.6% | |
| HOF 1 | | 14.5% | 52% |
| LOF 1 | | 2.3% | 48% |
| Grain 2 | 16% | 6.7% | |
| HOF 2 | | 13.5% | 43% |
| LOF 2 | | 1.7% | 57% |

These results indicate that the oil level in over half of the corn material is reduced to less than 2.5 wt. % of the LOF, allowing this fraction to bypass the expensive extraction step.

Unless otherwise defined, all technical and scientific terms and abbreviations used herein have the same meaning as commonly understood by one of ordinary skill in the art to which this invention pertains. Although methods and materials similar or equivalent to those described herein can be used in the practice of the present invention, suitable methods and materials are described below without intending that any such methods and materials limit the invention described herein. All patents publications and official analytical methods referred to herein are incorporated by reference in their entirety. Additional features and advantages of the present invention will be apparent from the following description of illustrative embodiments of the present invention and from the claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the present invention.

1. A method of generating energy from one or more portions of whole corn kernels comprising:
separating one or more whole corn kernels into one or more portions;
oxidizing at least one of the one or more portions to create one or more types of energy.

2. The method according to claim 1, wherein the one or more types of energy is selected from the group consisting of thermal energy and electrical energy.

3. The method according to claim 1, wherein the one or more portions of whole kernel corn are selected from the group consisting of LSF, and HSF.

4. The method according to claim 1, further comprising using at least one of the one or more portions of whole kernel corn to make one or more products.

5. The method according to claim 3, wherein the one or more portion of whole kernel corn is LSF and wherein the LSF contains less than 50% intact germ.

6. The method according to claim 4, wherein the one or more products are selected from the group consisting of starch, high fructose corn syrup, corn syrup, sweeteners, fermentation feedstock, extracted LSF, DDGs, animal feed, bran, grits, gluten meal and combinations thereof.

7. The method according to claim 1, further comprising using the one or more portions of whole kernel corn to make one or more by-products.

8. The method of claim 4, wherein the one or more by-products are oxidized to make energy.

9. The method according to claim 1, wherein oxidation is achieved using gasification or combustion.

10. A method of dividing a corn kernel comprising:
fractionating at least one corn kernel having a range of moisture from about 8 wt. % to about 22 wt. %, and further having an endosperm component and a germ component, into a higher starch fraction and a lower starch fraction, wherein, the higher starch fraction has an starch concentration greater than that of the corn kernel and the lower starch fraction has an starch concentration less than that of the corn kernel, and wherein the low starch fraction contains less than 50% intact germ.

11. The method of claim 10, further comprising using at least a portion of the high starch fraction for one or more processes selected from the group consisting of; energy production, fermentation, oil production, wet-milling, animal feed production, sweetener production, and starch production.

12. The method of claim 10, further comprising using at least a portion of the low starch fraction for one or more processes selected from the group consisting of; energy production, fermentation, oil production, wet-milling, animal feed production, sweetener production, and starch production.

13. The method according to claim 10, wherein the fractionating is accomplished using a mechanical debranning machine.

14. The method according to claim 12, further comprising expanding the low starch fraction prior to oil extraction.

15. A method of producing one or more products from a corn milling plant, the method comprising:
fractionating at least one whole corn kernel into at least two portions; and
producing energy and at least one additional product from the at least two portions.

16. The method according to claim 15, wherein the at least one additional product is selected from the group consisting of starch, high fructose corn syrup, corn syrup, sweeteners, fermentation feedstock, extracted LSF, DDGs, animal feed, bran, grits, gluten meal and combinations thereof.

17. The method according to claim 15, wherein fractionating is accomplished using dry-milling processes, wet-milling processes, or a combination thereof.
